(19) United States
(12) Patent Application Publication
(10) Pub. No.: US 2024/0334346 A1
(43) Pub. Date: Oct. 3, 2024

(54) COMMUNICATION DEVICE

(71) Applicant: Panasonic Automotive Systems Co., Ltd., Kanagawa (JP)

(72) Inventor: Hungwu CHIANG, Kanagawa (JP)

(73) Assignee: Panasonic Automotive Systems Co., Ltd., Kanagawa (JP)

(21) Appl. No.: 18/743,264

(22) Filed: Jun. 14, 2024

Related U.S. Application Data
(63) Continuation of application No. PCT/JP2022/029539, filed on Aug. 1, 2022.

(30) Foreign Application Priority Data
Dec. 24, 2021 (JP) 2021-210927

(51) Int. Cl. H04W 52/28; H04W 52/26

(52) U.S. Cl. CPC H04W 52/283; H04W 52/26

(57) ABSTRACT

A communication device mounted on a first vehicle, the communication device includes a wireless communication unit configured to receive second information that is periodically transmitted from a second vehicle and includes at least position information of the second vehicle, and a control unit configured to specify a distance between the first vehicle and the second vehicle based on the second information, transmit first information indicating presence of the first vehicle through the wireless communication unit when the distance is less than a threshold, and not transmit the first information when the distance is equal to or larger than the threshold.

### CROSS-REFERENCE TO RELATED APPLICATIONS

This is a continuation of International Application No. PCT/JP2022/029539 filed on Aug. 1, 2022, and claims priority from Japanese Patent Application No. 2021-210927 filed on Dec. 24, 2021, the entire content of which is incorporated herein by reference.

### TECHNICAL FIELD

The present disclosure relates to a communication device.

### BACKGROUND ART

In a system for avoiding collision of a vehicle with a warning target of a communication terminal by performing wireless communication between the communication terminal and the vehicle, a technique for reducing power consumption of the communication terminal has been studied. Patent Literature 1 discloses an information acquisition system in which an in-vehicle device mounted on a vehicle and a communication terminal held by a warning target existing around the vehicle can communicate with each other, and the in-vehicle device acquires information of the warning target from the communication terminal. The in-vehicle device disclosed in Patent Literature 1 detects a reception state of a radio wave from the communication terminal, determines whether to request information from the communication terminal based on a detection result thereof, transmits a request for acquiring the information to the communication terminal when it is determined to request the information, and acquires the information transmitted from the communication terminal in response to the transmitted request.

### CITATION LIST

### Patent Literature

Patent Literature 1: JP2008-225572A
Patent Literature 2: JP2007-233684A

However, in a configuration disclosed in Patent Literature 1, the communication terminal needs to constantly monitor the request transmitted from the in-vehicle device, and thus it is insufficient to reduce power consumption in the communication terminal.

An object of the present disclosure is to reduce power consumption in a communication device that performs wireless communication with a vehicle.

### SUMMARY OF INVENTION

A communication device according to an aspect of the present disclosure is a communication device mounted on a first vehicle. The communication device includes: a wireless communication unit configured to receive second information that is periodically transmitted from a second vehicle and includes at least position information of the second vehicle; and a control unit configured to specify a distance between the first vehicle and the second vehicle based on the second information, transmit first information indicating presence of the first vehicle through the wireless communication unit when the distance is less than a threshold, and not transmit the first information when the distance is equal to or larger than the threshold.

These comprehensive or specific aspects may be implemented by a system, a device, a method, an integrated circuit, a computer program, or a recording medium, or any combination of the system, the device, the method, the integrated circuit, the computer program, and the recording medium.

According to the present disclosure, it is possible to reduce power consumption in a communication device that performs wireless communication with a vehicle.

### BRIEF DESCRIPTION OF DRAWINGS

FIG. 1 is a schematic diagram showing an example of a use mode of a communication device according to an embodiment;

FIG. 2 is a block diagram showing a configuration example of a communication system according to the present embodiment;

FIG. 3 is a schematic diagram showing a condition for transmitting first information when a notification button is pressed;

FIG. 4 is a schematic diagram showing control of transmission power when the first information is transmitted when the notification button is pressed;

FIG. 5 is a flowchart showing an example of distance threshold determination processing executed by the communication device according to the present embodiment;

FIG. 6 is a flowchart showing an example of transmission processing of the first information executed by the communication device according to the present embodiment;

FIG. 7 is a flowchart showing an example of transmission processing of second information executed by a vehicle according to the present embodiment; and

FIG. 8 is a flowchart showing an example of transmission power determination processing executed by the communication device according to the present embodiment.

### DESCRIPTION OF EMBODIMENTS

Hereinafter, an embodiment of the present disclosure will be described in detail with reference to the drawings as appropriate. However, more detailed description may be omitted. For example, detailed description of already well-known matters and redundant description of substantially the same configuration may be omitted. This is to avoid unnecessary redundancy of the following description and to facilitate understanding of a person skilled in the art. The accompanying drawings and the following description are provided for a person skilled in the art to fully understand the present disclosure, and are not intended to limit the subject matter described in the claims.

### Present Embodiment

### <Outline>

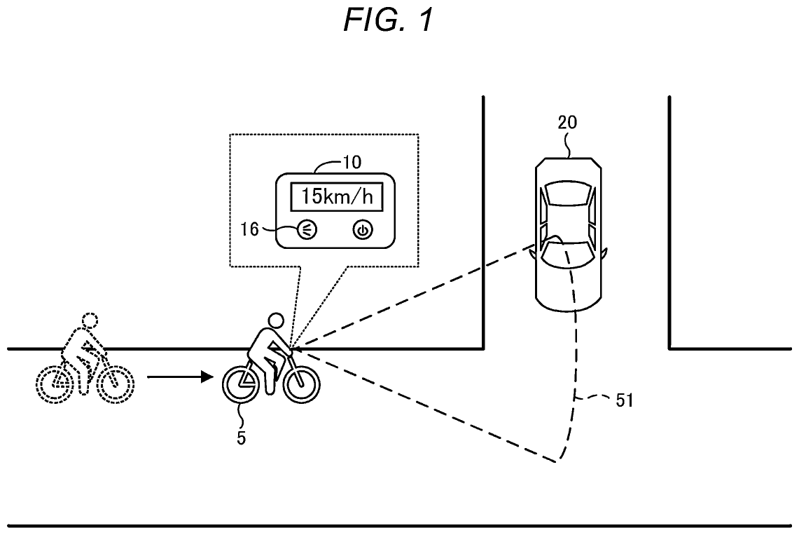

FIG. 1 is a schematic diagram showing an example of a use mode of a communication device 10 according to the present embodiment. In the present embodiment, when vehicles are distinguished from each other, reference signs are represented by a combination of numerals and alphabets as in vehicles 20A, 20B, and 20C, and when the vehicles are not distinguished from each other, reference signs are represented only by numerals as in a vehicle 20.

As shown in FIG. 1, the communication device 10 according to the present embodiment is mounted on a handlebar of a bicycle 5 which is an example of a vehicle. For example, when a driver of the bicycle 5 approaches an intersection with poor visibility and presses a notification button 16 of the communication device 10, the communication device 10 broadcasts, as a wireless signal, information (hereinafter, referred to as first information) 51 to notify the presence of the bicycle 5.

When the vehicle 20 present in the vicinity of the bicycle 5 receives the first information 51 transmitted from the communication device 10, the vehicle 20 notifies a driver of the vehicle 20 that the bicycle 5 is present in the vicinity. Accordingly, the driver of the vehicle 20 entering the intersection with poor visibility can know that the bicycle 5 is present in the vicinity, and can avoid collision of the vehicle 20 with the bicycle 5. In addition, when the first information 51 is received, the vehicle 20 may automatically decelerate or stop. Accordingly, it is possible to automatically avoid the collision of the vehicle 20 with the bicycle 5.

However, since the communication device 10 mounted on the bicycle 5 is required to be small and lightweight, it is difficult to mount a large-capacity power supply. Accordingly, the communication device 10 is required to reduce power consumption. Hereinafter, a technique for reducing the power consumption in the communication device 10 will be described. However, the communication device 10 is not limited to be mounted on the bicycle 5, and may be mounted on various vehicles such as a bike (motorcycle) or an automobile. In addition, the communication device 10 is not limited to be mounted on a vehicle, and may be mounted on or built in a mobile terminal (for example, a smartphone) carried by a pedestrian.

### <Configuration of Communication System>

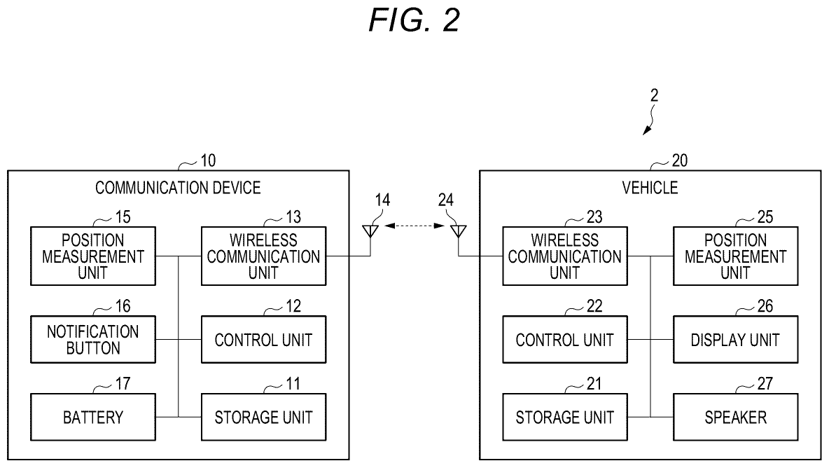

FIG. 2 is a block diagram showing a configuration example of a communication system according to the present embodiment.

As shown in FIG. 2, a communication system 2 includes the communication device 10 and the vehicle 20. The communication device 10 and the vehicle 20 may be capable of performing V2X communication (wireless communication) with each other. The V2X communication may include at least one of vehicle to infrastructure (V2I) communication, vehicle to vehicle (V2V) communication, vehicle to pedestrian (V2P) communication, and vehicle to network (V2N) communication. Examples of the V2X communication method include dedicated short range communications (DSRC) and cellular-V2x (C-V2X). The V2X communication method may correspond to 4G or 5G.

### <<Configuration of Communication Device>>

The communication device 10 includes a storage unit 11, a control unit 12, a wireless communication unit 13, an antenna 14, a position measurement unit 15, the notification button 16, and a battery 17.

The storage unit 11 stores data, a computer program, and the like handled by the control unit 12. The storage unit 11 may be implemented by a read-only memory (ROM), a random access memory (RAM), a flash memory, or a combination thereof.

The control unit 12 implements functions of the communication device 10 by reading and executing the data and the computer program stored in the storage unit 11. The control unit 12 may be read as another term such as a control circuit, an arithmetic circuit, a processor, a controller, a central processing unit (CPU), or a large scale integrated circuit (LSI). In the following description, processing mainly performed by the communication device 10 may be read as processing mainly performed by the control unit 12 provided in the communication device 10.

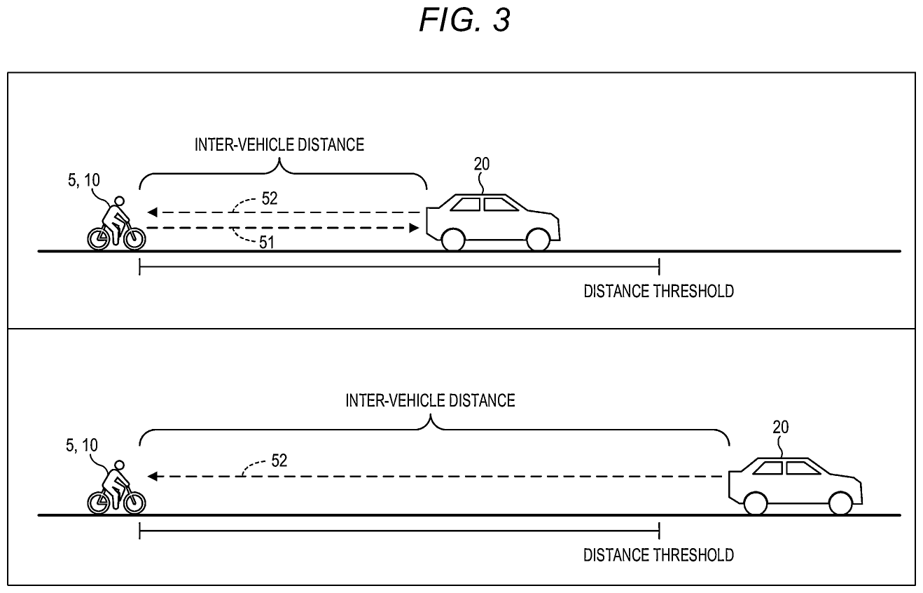

The wireless communication unit 13 transmits and receives a wireless signal through the antenna 14. For example, the wireless communication unit 13 transmits and receives a basic safety message (BSM) by the V2X communication. The BSM may be an example of the first information 51 and second information 52 (see FIG. 3) in the present embodiment. The antenna 14 may be a so-called directional antenna having directivity of radio waves in a traveling direction of the communication device 10 (in front of the bicycle 5).

The position measurement unit 15 measures a current position of the communication device 10 (bicycle 5). For example, the position measurement unit 15 receives a global navigation satellite systems (GNSS) signal, measures longitude and latitude indicating the current position, and generates position information including the measured current position and a measured time. The control unit 12 may calculate a moving speed of the communication device 10 (the bicycle 5) based on a moving amount per unit time of the current position indicated by the position information acquired from the position measurement unit 15.

The notification button 16 is a button that is pressed when the driver of the bicycle 5 wants to notify the surrounding vehicle 20 that the driver is present. When the notification button 16 is pressed, as described in FIG. 1, the control unit broadcasts the first information 51 through the wireless communication unit 13 and the antenna 14. The notification button 16 is an example of an input unit, and a configuration of the input unit is not limited to a button. For example, the input unit may be a touch panel, a switch, a lever, and the like. The battery 17 supplies power to the storage unit 11, the control unit 12, the wireless communication unit 13, the position measurement unit 15, and the like. The battery may be a primary battery or a secondary battery. When the communication device 10 is mounted on a bicycle with electric assist, a battery mounted on the bicycle with electric assist may be used as the battery 17 of the communication device 10. When the communication device 10 is mounted on a bike (or an automobile), a battery mounted on the bike (or the automobile) may be used as the battery 17 of the communication device 10.

### <<Configuration of Vehicle>>

The vehicle 20 includes a storage unit 21, a control unit 22, a wireless communication unit 23, an antenna 24, a position measurement unit 25, a display unit 26, and a speaker 27. The storage unit 21, the control unit 22, and the wireless communication unit 23 may be implemented as an electronic control unit (ECU).

The storage unit 21 stores data, a computer program, and the like handled by the control unit 22.

The control unit 22 implements functions of the vehicle 20 by reading and executing the data and the computer program stored in the storage unit 21. In the following description, processing mainly performed by the vehicle 20 may be read as processing mainly performed by the control unit 22 provided in the vehicle 20.

The wireless communication unit 23 transmits and receives a wireless signal through the antenna 24. For example, the wireless communication unit 23 transmits and receives the BSM by the V2X communication.

The position measurement unit 25 measures a current position of the vehicle 20. For example, the position measurement unit 25 receives a GNSS signal, measures longitude and latitude indicating the current position, and generates position information including the measured current position and a measured time.

The display unit 26 is provided in the vehicle 20 and outputs various types of image information to the driver of the vehicle 20. Examples of the display unit 26 include a liquid crystal display or an organic EL display. For example, when the wireless communication unit 23 receives the first information 51, the display unit 26 outputs image information indicating that the bicycle 5 is present in the vicinity.

The speaker 27 is provided in the vehicle 20 and outputs various types of voice information to the driver of the vehicle 20. For example, when the wireless communication unit 23 receives the first information 51, the speaker 27 outputs voice information indicating that the bicycle 5 and the like is present in the vicinity.

### <Condition for Transmission of First Information>

FIG. 3 is a schematic diagram showing a condition for transmitting the first information 51 when the notification button 16 is pressed.

When the notification button 16 is pressed, the communication device 10 calculates a distance (hereinafter, referred to as an inter-vehicle distance) between the communication device 10 (the bicycle 5) and the vehicle 20. For example, the communication device 10 calculates the inter-vehicle distance based on the position information of the vehicle 20 included in the second information 52 periodically transmitted from the vehicle 20 and the position information of the communication device 10 generated by the position measurement unit 15.

When the inter-vehicle distance is less than a distance threshold, the communication device 10 transmits the first information 51 as shown in (a) of FIG. 3. When the inter-vehicle distance is equal to or larger than the distance threshold, the communication device 10 does not transmit the first information 51 as shown in (b) of FIG. 3. This is because, even when the presence of the bicycle 5 is notified to the vehicle 20 located sufficiently far from the bicycle 5, there is no effect on collision avoidance. Accordingly, it is possible to reduce the power consumption of the communication device 10 by preventing transmission of the unnecessary first information 51.

The communication device 10 may change the distance threshold according to the moving speed of the communication device 10 (that is, the moving speed of the bicycle 5). For example, the communication device 10 increases the distance threshold as the moving speed increases, and decreases the distance threshold as the moving speed decreases. Alternatively, the communication device 10 may increase the distance threshold stepwise as the moving speed increases. For example, the communication device 10 sets a first distance threshold (for example, 100 m) when the moving speed is 0 km or more and less than a first speed threshold (for example, 20 km/h), and sets a second threshold (for example, 200 m) when the moving speed is the first speed threshold or more and less than a second speed threshold (for example, 40 km/h). As described above, by setting an appropriate distance threshold according to the moving speed of the communication device 10, for example, when the moving speed of the bicycle 5 is slow and the vehicle 20 is located far, the first information 51 is not transmitted. Accordingly, the power consumption of the communication device 10 can be reduced. On the other hand, when the moving speed of the bicycle 5 is fast, since the first information 51 is transmitted even when the position of the vehicle 20 is far, and thus the collision between the bicycle 5 and the vehicle 20 can be sufficiently avoided.

### <Control of Transmission Power of First Information>

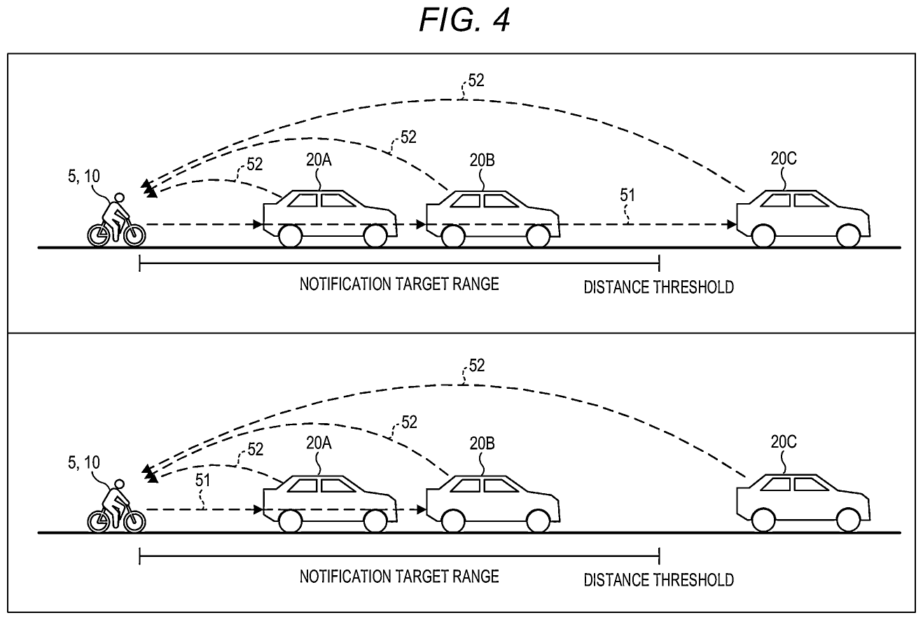

FIG. 4 is a schematic diagram showing control of the transmission power when the first information 51 is transmitted when the notification button 16 is pressed.

When the first information 51 is transmitted through the wireless communication unit 13 and the antenna 14, the communication device 10 broadcasts the first information 51 by controlling transmission power such that the first information 51 reaches a farthest vehicle 20B among a plurality of vehicles 20A and 20B present in a range (hereinafter, referred to as a notification target range) from the current position of the communication device 10 to a position indicated by the distance threshold in the moving direction of the communication device 10 (that is, in front of the bicycle 5).

For example, as shown in (a) of FIG. 4, when the communication device 10 receives the second information 52 periodically transmitted from each of the vehicles 20A, 20B, and 20C and recognizes the presence of the vehicle 20, the communication device 10 broadcasts the first information 51 including a reception level request. The reception level request is a command for requesting a reception level of the vehicle 20 when the vehicle 20 (wireless communication unit 23) receives a wireless signal including the first information 51. Examples of the reception level include received signal strength indicator (RSSI), reference signal received power (RSRP), and reference signal received quality (RSRQ). When the first information 51 including the reception level request is received, each of the vehicles 20A, 20B, and 20C measures the reception level related to the first information 51 and transmits the second information 52 (ACK for the first information 51) including the reception level. The second information 52 includes the position information of the vehicle 20 and identification information of the vehicle 20.

Next, as shown in (b) of FIG. 4, the communication device 10 receives the second information 52 from the vehicles 20A, 20B, and 20C, and calculates an inter-vehicle distance between the communication device 10 and each of the vehicles 20A, 20B, and 20C based on position information of the vehicles 20A, 20B, and 20C included in the second information 52. Then, the communication device 10 specifies the farthest vehicle 20B among the vehicles 20A and 20B present in the notification target range. Next, the communication device 10 calculates transmission power that can cause the first information 51 to reach the vehicle 20B based on the reception level included in the second information 52 transmitted from the vehicle 20B, and broadcasts the first information 51 by the transmission power. That is, the communication device 10 transmits the first information 51 by such transmission power that can cause the first information 51 to reach the vehicle 20B located farthest in the notification target range and does not need to cause the first information 51 to reach a position farther than the farthest vehicle 20B.

Accordingly, in the present embodiment, the transmission power can be reduced as compared with the case where the first information 51 is transmitted by the transmission power that can cause the first information 51 to reach the vehicle 20C present outside the notification target range. Further, the present embodiment can reduce the transmission power as compared with the case where the first information 51 is transmitted by the transmission power that can cause the first information 51 to reach a far end of the notification target range (that is, the position of the distance threshold). Accordingly, the power consumption of the communication device 10 can be reduced.

The communication device 10 performs the above-described calculation of the transmission power for each transmission cycle of the first information 51. Accordingly, even when the distance to the vehicle 20B changes, the communication device 10 can broadcast the first information 51 by transmission power optimum for the distance.

The communication device 10 may transmit the first information 51 through the antenna 14 having directivity in the moving direction of the communication device 10 (that is, in front of the bicycle 5). Accordingly, as compared with a case where the first information 51 is transmitted through an omnidirectional antenna, it is possible to cause the wireless signal to reach farther than the front of the bicycle 5 with power saving. Accordingly, it is possible to reduce power consumption when the first information 51 of the communication device 10 is transmitted.

Next, processing executed by the communication device 10 and the vehicle 20 according to the present embodiment will be described.

### <Distance Threshold Determination Processing>

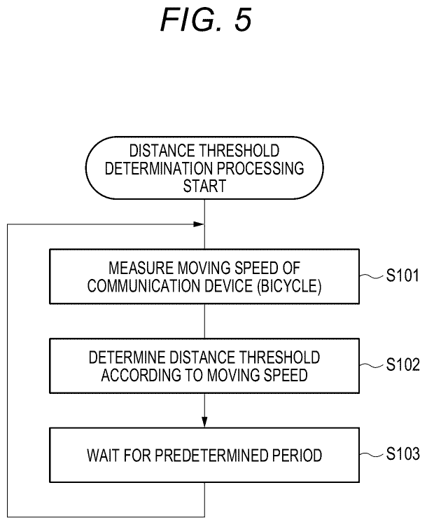

FIG. 5 is a flowchart showing an example of distance threshold determination processing executed by the communication device 10 according to the present embodiment. The communication device 10 may constantly or appropriately execute the present processing.

The communication device 10 measures the moving speed of the communication device 10 (or the bicycle 5) (S101). For example, the communication device 10 measures the moving speed based on the moving amount per unit time of the current position measured by the position measurement unit 15. Alternatively, when a speed meter is mounted on the bicycle 5, the communication device 10 may acquire a speed measured by the speed meter as the moving speed.

The communication device 10 determines a distance threshold according to the speed measured in step S101 (S102).

After the communication device 10 waits for a predetermined period (for example, one second) (S103), the processing returns to step S101.

Through the above processing, the communication device 10 can determine the distance threshold according to the moving speed of the communication device 10 (or the bicycle 5).

### <Transmission Processing of First Information>

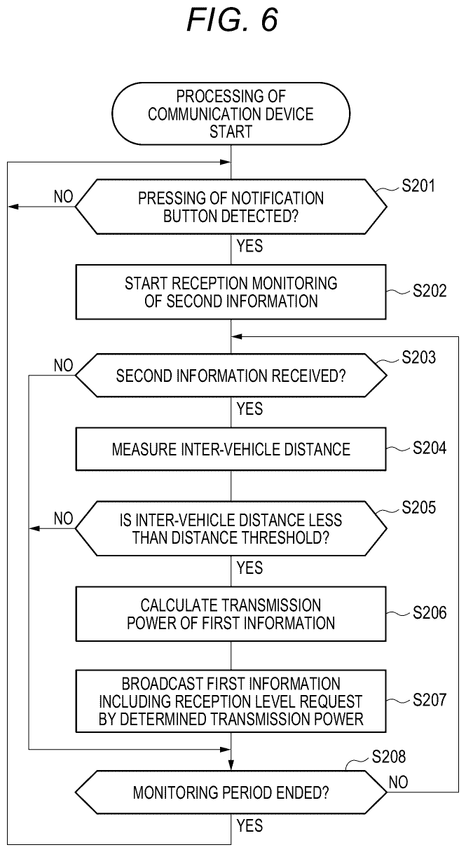

FIG. 6 is a flowchart showing an example of transmission processing of the first information 51 executed by the communication device 10 according to the present embodiment.

The communication device 10 determines whether pressing of the notification button 16 is detected (S201).

When the pressing of the notification button 16 is not detected (S201: NO), the communication device 10 repeats the processing of step S201, and when the pressing of the notification button 16 is detected (S201: YES), the processing proceeds to the next step S202.

The communication device 10 starts reception monitoring of the second information 52 periodically transmitted from the vehicle 20 (S202), and determines whether the second information 52 is received (S203).

When the second information 52 is not received by the communication device 10 (S203: NO), the processing proceeds to step S208 described later, and when the second information 52 is received (S203: YES), the processing proceeds to the next step S204.

The communication device 10 measures the inter-vehicle distance based on the position information measured by the position measurement unit 15 of the communication device 10 and the position information of the vehicle 20 included in the received second information 52 (S204).

The communication device 10 determines whether the inter-vehicle distance measured in step S204 is less than the distance threshold determined in the processing shown in FIG. 5 (S205). As described with reference to FIGS. 3 and 5, the distance threshold may change according to the moving speed of the communication device 10 (the bicycle 5).

When the communication device 10 determines that the inter-vehicle distance is equal to or larger than the distance threshold (S205: NO), the processing proceeds to step S208 described later, and when the inter-vehicle distance is less than the distance threshold (S205: YES), the processing proceeds to the next step S206.

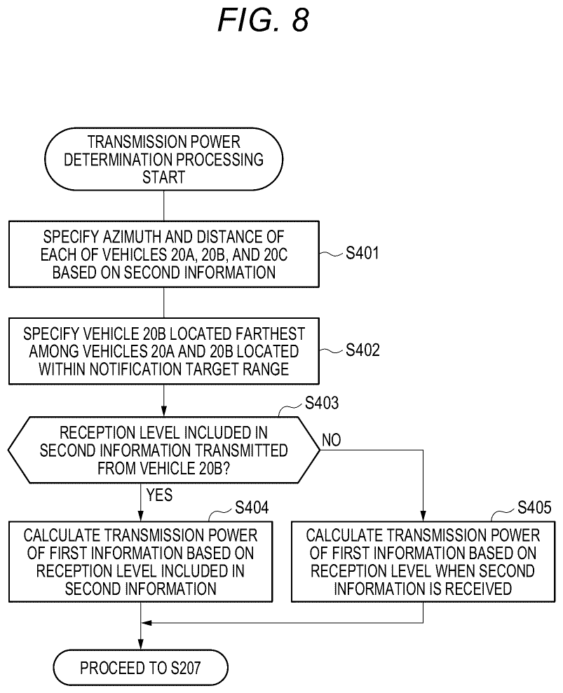

As described with reference to FIG. 4, the communication device 10 determines transmission power of the first information 51 (S206). Details of determination processing of the transmission power will be described later (see FIG. 8). In addition, the communication device 10 may not perform the determination processing of the transmission power. In this case, the communication device 10 may set, as the transmission power of the first information 51, transmission power that can cause the first information 51 to reach the far end of the notification target range.

The communication device 10 broadcasts the first information 51 including the reception level request by the transmission power determined in step S206 (S207). Here, the second information 52 as a response (ACK) to the transmitted first information 51 may be received in the next step S203. Accordingly, as described with reference to FIG. 4, the first information 51 is received by the vehicle 20B located farthest in the notification target range and the vehicle 20A located closer to the vehicle 20B.

The communication device 10 determines whether a reception monitoring period of the second information 52 has ended (S208). The reception monitoring period may be a predetermined certain period.

When the reception monitoring period of the second information 52 has not ended (S208: NO), the communication device 10 returns the processing to step S203, and when the reception monitoring period of the second information 52 has ended (S208: YES), the communication device 10 returns the processing to step S201.

Through the above processing, when the notification button 16 is pressed, the communication device 10 can notify the vehicles 20A and 20B located within the notification target range that the bicycle 5 is present while reducing the power consumption.

### <Transmission Processing of Second Information>

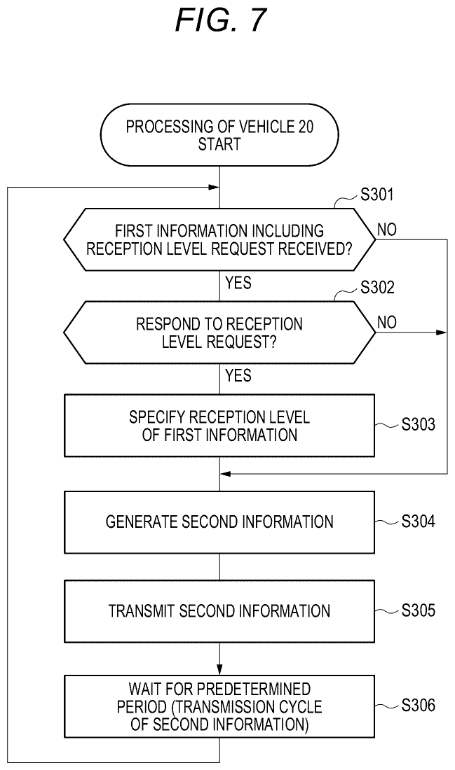

FIG. 7 is a flowchart showing an example of transmission processing of the second information 52 executed by the vehicle 20 according to the present embodiment.

The vehicle 20 determines whether the first information 51 including the reception level request is received from the communication device 10 mounted on the bicycle 5 (S301). When the first information 51 including the reception level is not received by the vehicle 20 (S301: NO), the processing proceeds to step S304 described later.

When the first information 51 including the reception level is received (S301: YES), the vehicle 20 determines whether the vehicle 20 can respond to the reception level request (S302). When the vehicle 20 cannot respond to the reception level request (S302: NO), the processing proceeds to step S304 described later.

When the vehicle 20 can respond to the reception level request (S302: YES), the vehicle 20 specifies a reception level of the first information 51 as described in FIG. 4 (S303).

The vehicle 20 generates the second information 52 (S304). At this time, the vehicle 20 may include the position information and the identification information of the vehicle 20 in the second information 52. In addition, when the reception level of the first information 51 is specified in step S303, the vehicle 20 includes the specified reception level in the second information 52.

The vehicle 20 transmits the second information 52 generated in step S304 through the wireless communication unit 23 and the antenna 24 (S305). Then, the vehicle 20 waits for a predetermined period (S306), and then the processing returns to step S301. The predetermined period may be a period corresponding to a transmission cycle of the second information 52.

Through the above processing, the vehicle 20 can notify, by using the second information 52, the communication device 10 of the reception level of the first information 51 transmitted from the communication device 10. In addition, the vehicle 20 can transmit the position information and the identification information of the vehicle 20 to the communication device 10 using the second information 52.

### <Transmission Power Determination Processing>

FIG. 8 is a flowchart showing an example of transmission power determination processing executed by the communication device 10 according to the present embodiment. The present processing corresponds to detailed description of the processing of step S206 shown in FIG. 6. In addition, in order to make the description easy to understand, the present processing is described using the vehicles 20A, 20B, and 20C shown in FIG. 4.

The communication device 10 specifies an azimuth and a distance of each of the vehicles 20A, 20B, and 20C viewed from the communication device 10 based on the position information included in the second information 52 received from each of the vehicles 20A, 20B, and 20C (S401).

The communication device 10 specifies, based on the azimuth and the distance of each of the vehicles 20A, 20B, and 20C specified in step S401, a vehicle 20B located farthest among the vehicles 20A and 20B located within the notification target range in the moving direction of the communication device 10 (in front of the bicycle 5) (S402).

The communication device 10 determines whether the reception level is included in the second information 52 transmitted from the farthest vehicle 20B (S403).

When the reception level is included in the second information 52 transmitted from the vehicle 20B (S403: YES), the communication device 10 calculates the transmission power of the first information 51 based on the reception level included in the second information 52 (S404), and the processing proceeds to step S207 shown in FIG. 6.

When the reception level is not included in the second information 52 transmitted from the vehicle 20B (S403: NO), the communication device 10 calculates the transmission power of the first information 51 based on a reception level of the wireless signal when the second information 52 transmitted from the vehicle 20B is received (S405), and the processing proceeds to step S207 shown in FIG. 6. For example, in the processing shown in FIG. 6, since the reception level may not be included in the second information 52 received in the first step S203 after the notification button 16 is pressed, the communication device 10 may calculate the transmission power of the first information 41 by the processing of step S405.

Through the above processing, it is possible to calculate the transmission power for causing the first information 51 to reach the vehicle 20B located farthest in the notification target range.

### Summary of Present Disclosure

Contents of the present disclosure can be expressed as the following appendixes.

### <Appendix 1>

A communication device (10) mounted on a first vehicle (5) includes: a wireless communication unit (13) configured to receive second information (52) that is periodically transmitted from a second vehicle (20) and includes at least position information of the second vehicle; and a control unit (12) configured to specify a distance (inter-vehicle distance) between the first vehicle and the second vehicle based on the second information, transmit first information (51) indicating presence of the first vehicle through the wireless communication unit when the distance is less than a threshold (distance threshold), and not transmit the first information when the distance is equal to or larger than the threshold.

Accordingly, when the distance between the first vehicle and the second vehicle is equal to or larger than the threshold, the communication device can reduce power consumption by not transmitting the first information.

### <Appendix 2>

In the communication device according to appendix 1, the control unit (12) may determine the threshold according to a moving speed of the first vehicle.

Accordingly, the communication device can appropriately change, according to the moving speed, a range (notification target range) in which the presence of the first vehicle is notified.

### <Appendix 3>

In the communication device according to appendix 1 or 2, the first information may include a request of a reception level of the first information, and the control unit may determine transmission power of the first information based on the reception level transmitted from the second vehicle that receives the first information.

Accordingly, the communication device can transmit the first information by appropriate transmission power that can cause the first information to reach the second vehicle, thereby reducing the power consumption.

### <Appendix 4>

In the communication device according to appendix 3, the control unit (12) may determine the transmission power of the first information based on the reception level transmitted from the second vehicle farthest from the first vehicle among a plurality of the second vehicles located within a range less than the threshold.

Accordingly, the communication device can transmit the first information by appropriate transmission power that can cause the first information to reach the second vehicle located farthest in the range (notification target range) in which the presence of the first vehicle is notified. Accordingly, the communication device can reduce the power consumption.

### <Appendix 5>

The communication device according to any one of appendixes 1 to 4 further includes an antenna having directivity in a moving direction of the first vehicle, and the wireless communication unit may transmit the first information through the antenna.

Accordingly, the communication device can transmit the first information to a farther distance by smaller transmission power in the moving direction of the first vehicle.

Accordingly, the communication device can reduce the power consumption.

### <Appendix 6>

A communication device (10) mounted on a first vehicle (5) includes: an input unit (for example, notification button 16) configured to detect an input from a driver of the first vehicle; and a wireless communication unit (13) configured to receive second information (52) periodically transmitted from a second vehicle, in which reception of the second information is monitored for a certain period when the input is detected by the input unit, and first information (51) indicating presence of the first vehicle is transmitted through the wireless communication unit when the second information is received.

Accordingly, the communication device transmits the first information when the driver inputs the first information to the input unit and receives the second information, that is, when the second vehicle is present in the vicinity. In other words, the communication device does not transmit the first information when the driver does not input the first information to the input unit, or when the second information is not received, that is, when the second vehicle is not present in the vicinity. Accordingly, the communication device can reduce the power consumption.

### <Appendix 7>

The communication device according to appendix 6 further includes an antenna having directivity in a moving direction of the first vehicle, and the wireless communication unit may transmit the first information through the antenna.

Accordingly, the communication device can transmit the first information to a farther distance by smaller transmission power in the moving direction of the first vehicle. Accordingly, the communication device can reduce the power consumption.

Although the embodiment has been described above with reference to the accompanying drawings, the present disclosure is not limited thereto. It is apparent to a person skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the embodiment described above may be freely combined without departing from the gist of the invention.

### INDUSTRIAL APPLICABILITY

The technique of the present disclosure is useful for a communication device that notifies another vehicle of the presence of the vehicle by using wireless communication.

What is claimed is:

1. A communication device mounted on a first vehicle, the communication device comprising:
a wireless communication unit configured to receive second information that is periodically transmitted from a second vehicle and includes at least position information of the second vehicle; and
a control unit configured to specify a distance between the first vehicle and the second vehicle based on the second information, transmit first information indicating presence of the first vehicle through the wireless communication unit when the distance is less than a threshold, and not transmit the first information when the distance is equal to or larger than the threshold.

2. The communication device according to claim 1,
wherein the control unit determines the threshold according to a moving speed of the first vehicle.

3. The communication device according to claim 1,
wherein the first information includes a request of a reception level of the first information, and
wherein the control unit determines transmission power of the first information based on the reception level transmitted from the second vehicle that receives the first information.

4. The communication device according to claim 3,
wherein the control unit determines the transmission power of the first information based on the reception level transmitted from the second vehicle farthest from the first vehicle among a plurality of the second vehicles located within a range less than the threshold.

5. The communication device according to claim 1, further comprising:
an antenna having directivity in a moving direction of the first vehicle,
wherein the wireless communication unit transmits the first information through the antenna.

6. A communication device mounted on a first vehicle, the communication device comprising:
an input unit configured to detect an input from a driver of the first vehicle; and
a wireless communication unit configured to receive second information periodically transmitted from a second vehicle,
wherein reception of the second information is monitored for a certain period when the input is detected by the input unit, and first information indicating presence of the first vehicle is transmitted through the wireless communication unit when the second information is received.

7. The communication device according to claim 6, further comprising:
an antenna having directivity in a moving direction of the first vehicle,
wherein the wireless communication unit transmits the first information through the antenna.
